(19) United States
(12) Patent Application Publication
(10) Pub. No.: US 2018/0090115 A1
(43) Pub. Date: Mar. 29, 2018

(54) POWER-MANAGEMENT SYSTEM FOR EFFECTS PEDALS

(71) Applicant: BandLab Technologies, Grand Cayman (KY)

(72) Inventors: Steve Skillings, Whitinsville, MA (US); Meng Ru Kuok, Singapore (SG)

(21) Appl. No.: 15/279,869

(22) Filed: Sep. 29, 2016

(51) Int. Cl. G10H 1/34; H02J 7/00

(52) U.S. Cl. CPC G10H 1/348; G10H 2230/035; H02J 7/0021; H02J 7/0042

(57) ABSTRACT

An apparatus for managing power provided to musical effects-pedals includes effects-pedal ports for providing power to each of a corresponding plurality of effects pedals, and a control system for controlling power supplied to each of the effects-pedal ports.

### FIELD OF INVENTION

This disclosure relates to effects pedals for electronic musical instruments, and in particular, to powering such effects pedals.

### BACKGROUND

Many musicians, especially guitar players, use electronic devices that alter an audio input signal. These units, which are often called “effects-units” or “effects-pedals,” can alter the signal in a variety of ways. Examples include delay and reverberation units, flangers and phasers, boosters, and distortion units. During a performance, a musician uses these effects-pedals to create various sounds.

In many cases, these effects-pedals are grouped into a pedal cluster and connected together so that the audio signal can pass from one pedal to the next. To improve portability of this pedal cluster, musicians often mount the pedals on platforms, or “pedal-boards.” These allow the pedals to be consistently organized for performance and readily packed away in a case for easy transport. Once the effects-pedals have been arranged in the musician's preferred order, they are secured to the board using any of a variety of methods including hook and loop fasteners, nylon tie wraps, and even duct tape.

These effects-pedals require power to modify the signal. Many of them have a built in battery compartment as well as a connector for supplying line power. The replaceable battery is often encased within the effects-pedal, which is typically screwed shut. Thus, changing the battery takes some time to carry out, and in some cases also requires a tool.

A solution to this difficulty is to use a single battery to power all the effects-pedals at once. This reduces the tedium associated with changing individual batteries.

Many pedal-boards plug into line power. Such pedal-boards require a cable. Depending on their placement on stage, they may also require lengthy extension cords that clutter the stage. However, despite this disadvantage, such line-powered pedal-boards offer useful features, such as ground loop isolation, status indicators, and power pass-through.

### SUMMARY

In one aspect, the invention features a power-management system having an onboard control-system that allows a musician to change, monitor, and track the electrical variables presented to effects-pedals in a way that promotes optimal creative performance, control, and reproducibility. Such reproducibility arises from an ability to store that data, to synchronize it with a computer system that saves the data redundantly, to share it on a social network, and in case the original power-management system is lost, replaced, or broken, to download that data from any computer, anywhere in the world.

In some embodiments, the onboard control-system carries out numerous functions. For power supplies that have a battery, the onboard control-system monitors the battery's charge capacity, its health, and the system temperature, which considerably affects battery performance.

The control system also adjusts the output voltage, amperage, and notification LEDs; turns ports on and off; reports the status of each port; turns the entire power-management system on or off; and causes transitions between power-management system states.

Another embodiment of the power-management system receives line power instead of relying on a battery. Like the battery reliant embodiment, the line-power embodiment has an on-board control-system that monitors and controls input and output electrical parameters, such as voltage and amperage. Because many effects-pedals may be enclosed in a small space, it is useful for the on-board control-system to also be able to monitor system temperature. The on-board control-system also controls a display, which can include LEDs and LCDs. It can also turn each port on and off, report the status of each port, turn the entire power-management system on or off, and transition between a plurality of power-management system states.

In some embodiments, the power-management system also connects to and transmits data to other devices such as a smart phone, computer, or similar digital device. It does so via a wireless connection, such as Wi-Fi, or Bluetooth, or via a wired connection, such as a USB cable. In such embodiments, software on a smart-phone, tablet or computer may interface with the power-management system. Such software can exist as software per se, and its converse, software per quod. Embodiments that represent software per se are disclaimed whereas software per quod is expressly within the scope of the claims.

Data transmitted from the power-management system can include power levels. This permits musicians who use a battery-reliant power-management system to know when it is time to recharge the battery.

In some embodiments, the on-board control-system also provides an estimate of remaining battery time. Such an estimate can be adaptive. It may, for example, rely on discharge rates, and on the musician's known habits. In such an embodiment, the power-management system will recognize a musician who is prone to heavy use of effects-pedals and reduce its estimate of remaining battery life accordingly.

In some embodiment, data communication is bidirectional. In these embodiments, the power-management system receives data from an external computing device. This data can include instructions for updating the power-management system's state, for turning output ports on and off, for turning the display or LEDs on and off, and for adjusting output port voltage and amperage. In cases where a musician has many different pedal-boards and power sources, different power-management systems can also be configured to work together via a cable, Wi-Fi_33, Bluetooth or some other method.

A power-management system that allows a musician to monitor and control power supplied to effects-pedals with a remote device via software and to monitor the state of a power supply has advantages for musicians. Such a power-management system allows the musician to know the state of its batteries, and to customize the output of each port to the needs of the effects-pedal connected to that port. It also enables the musician to know the rate of discharge, to predict when the battery will run out of charge, to alert the musician when the battery level gets below a predetermined level, to check the battery level before a performance, to shut down the power-management system via a sleep mode setting, thus saving power on breaks, to save and deploy presets of states of the device, to store data on the power-management system for synchronization with an external device at a later time, to share that data with others via a social network, to have a backup of all data on a server network or cloud system, and to manage a plurality of statuses, states, and actions.

In one aspect, the invention features a power-management system that includes one or more effects-pedal ports for providing power to each of a corresponding plurality of effects pedals, and a control system for controlling power supplied to each of the effects-pedal ports.

Among the embodiments are those that have an additional output port for supplying power to or charging an auxiliary device.

In some embodiments, the voltage from which the power is derived comes from a battery pack that provides a time-varying voltage. Among these battery-reliant embodiments are those in which the control system is configured to estimate battery lifetime based at least in part on both battery level and historical data indicative of a rate at which effects-pedals consume power. Also among the battery-reliant embodiments are those in which the control system is configured to maintain a count of battery charge cycles and to estimate battery lifetime at least in part on the basis of the count, as well as those in which the control system issues an alert when estimated battery lifetime falls below a threshold.

Also among the battery-reliant embodiments are those in which the power-management system daisy-chains multiple pedal boards. Some of these embodiments carry out power balancing if a first pedal board is consuming power faster than a second pedal board.

Other embodiments, instead of relying on a battery, have a line input for providing a time-varying voltage from which to derive the power supplied to each of the effects-pedal ports. Some of these embodiments also have a power converter for transforming the time-varying voltage into a DC voltage for the effects-pedal ports.

In some embodiments, the control system provides first and second effects-pedal ports with different outputs. Among these are embodiments in which the controller retrieves a pre-set from a set of pre-sets and applies the pre-set to the effects-pedal ports. In this case, the retrieved pre-set specifies the first and second outputs.

In other embodiments, the control system responds to an instruction to apply a particular voltage to an effects-pedal port by acting in a manner inconsistent with the instruction or by disobeying an instruction. This protects the effects pedal from damage resulting from improper voltages.

Also among the embodiments are those having a sensor for providing measurement data to the control system so that the control system can rely at least in part on that measurement data as a basis for control. A variety of sensors are possible, including temperatures sensors, sensors for measuring electrical variables, such as voltage and current at the effects-pedal ports, and photo sensors.

Also among the embodiments are those in which the control system is configured to avoid placing the power-management system in sleep mode while an effects-pedal is being used, and those that place the power-management in sleep mode after a specified interval of inactivity, or after prolonged periods of darkness.

In general, all software is either software per se or software per quod. As used herein, including in the claims, all software is software per quod. Software per se is specifically disclaimed.

Other embodiments feature an external computer having a tangible and non-transitory computer-readable medium having encoded thereon software per quod, the software per quod being configured to execute a concrete implementation of an abstract idea on the external computer, the software per quod being configured to interface with the power-management system.

In some embodiments, the software is configured to cause the power-management system to cease operation and to resume operation after having ceased operation.

In other embodiments, the software is configured to cause the power-management system to enable sharing of pre-sets via a social network.

In yet other embodiments, the software is configured to cause the power-management system to manage pre-sets for the output ports.

Still other embodiments, above and beyond the foregoing embodiments are those in which the software is configured to determine permissible outputs for a particular effects pedal.

The external computer can take on a variety of forms. For example, the external computer can be a smart-phone, a tablet, a notebook computer, a laptop, a desktop, and a tabletop computer. The external computer can also be a cloud-based computer.

In another aspect, the invention features an effects pedal in combination with any of the power-management systems as described above.

Also included within the scope of the invention are combinations and permutations of the foregoing features to the extent such combinations are not contradictory.

These and other features of the invention will be apparent from the following detailed description and the accompanying figures, in which

### BRIEF DESCRIPTION OF THE DRAWINGS

FIG. 1 shows the outer case, and inner components of the power-management system;

FIG. 2 shows the power-management system being used in conjunction with one or more control device and having connections to the internet; and

FIG. 3 shows the power-management system connected to other power-management systems.

### DETAILED DESCRIPTION

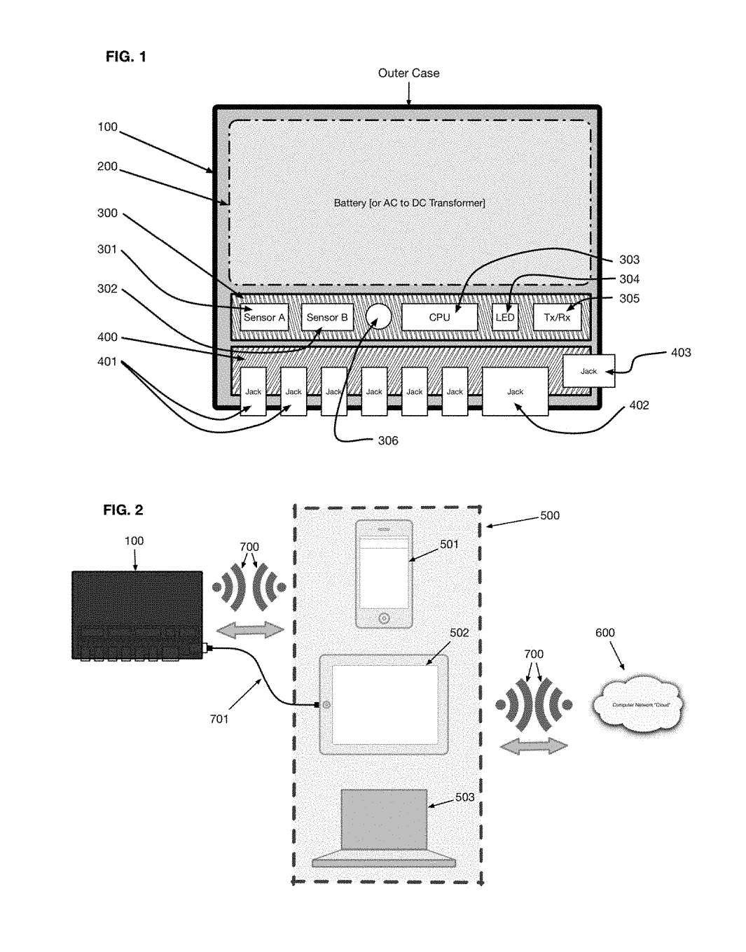

FIG. 1 shows a power-management system 100 having a power section 200. During normal operation, power flows through the power section 200. This power can come from a wall source or from an internal battery. In the former case, the power can be used to simultaneously charge the battery and operate the power-management system 100.

A control section 300 permits a musician to select from among a variety of functions.

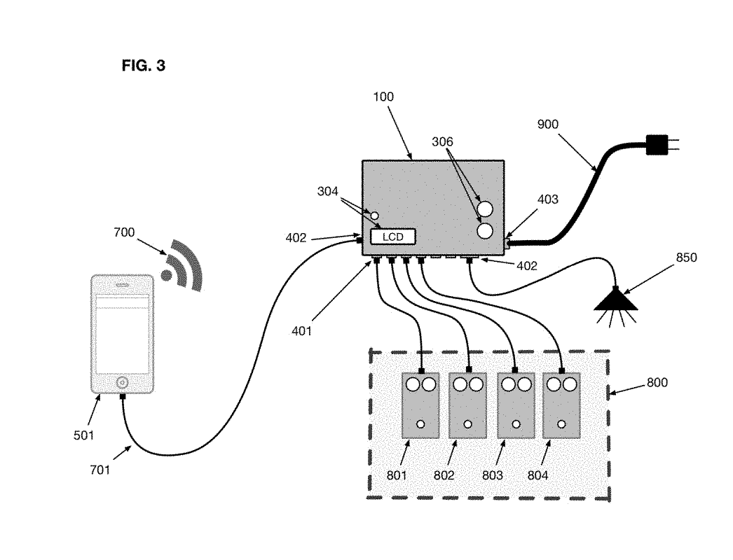

Finally, an I/O section 400 allows the power-management system 100 to connect to a plurality of effects-pedals 800, which are shown in FIG. 3.

In some embodiments, the power section 200 includes transformers for converting AC to DC. In other embodiments, the power section 200 controls only DC power, for example because the AC to DC transformer is outside the device case. Or, the power section 200 can have an internal battery, such as a lithium ion battery pack. Alternatively, an external power supply 900, as shown in FIG. 3, can be used when converting AC to DC from within the power-management system 100 is undesirable.

The control section 300 provides a way to control the various structures in the I/O section 400. This permits management of voltages, amperages, and other useful electrical parameters at the I/O section 400. In the particular embodiment shown, the control section 300 features sensors 301, 302, control actuators 306, such as knobs and buttons, a power-management processor 303, a display 304, such as an LCD or LED display, and communication circuitry 305.

In some embodiments, a local computer 500, as shown in FIG. 2, interfaces with the control section 300. In that case, the control actuators 306 would not be necessary. However, it is preferable for control actuators 306 to be integrated into the case where they are available for use whenever the local computer 500 is either unavailable or inconvenient.

The sensors 301, 302 permit measurement of useful quantities. The sensors 301, 302 provide these measurements to the power-management processor 303, which then uses them as the basis for feedback control over the various devices in the I/O section 400 as well as to control the display 304. Examples include internal and external quantities, such as the real time battery and output levels. However, the sensors 301, 302 are by no means limited to sensing electrical quantities. In some embodiments, a sensor 301 is a thermometer or thermocouple for measuring temperature.

Some embodiments include a photodetector for detecting light levels. This is useful for identifying circumstances under which it is safe to put the power-management system 100 to sleep, thereby saving battery life. For example, an extended absence of light could mean that the power-management system 100 is locked in the trunk of a car and that someone has forgotten to turn it off.

In other embodiments, the sensor 301 is an accelerometer that measures motion, or a GPS unit that measures location.

The power-management processor 303 connects to the communication circuitry 305. This communication circuitry 305 includes, for example, a transmitter and receiver circuit or chipset to transmit data to another device, such as one or more of the computers 500 shown in FIG. 2.

Referring to FIG. 2, the communication circuitry 305 provides a data communication path between the power-management system 100 and one or more computers 500. Examples of such computers 500 include a smart-phone 501, a tablet computer 502, and a notebook computer 503. The data communication path can be a wireless path 700 or a wired path 701 depending on the musician's preferences.

The I/O section 400 includes output ports 401, 402 that provide power to effects-pedals 800. The output ports 402 come in a variety of standard formats. Examples include a USB connector, a 2.5 mm barrel connector, and a proprietary connector, such as an Apple LIGHTNING (R) connector.

The I/O section 400 also includes one or more input ports 403 for receiving external AC or DC power. The power-management system 100 ultimately routs this power to the output ports 402. In some embodiment, the control section 300 controls these input ports 403. In particular, the control section 300 allows different input options, such as receiving power from an external power supply or another power-management system 100 to cascade battery power, to carry out power balancing, or to control draw.

As shown in FIG. 3, the input and output ports 401, 402, 403 may protrude through the case. In addition to providing power to the effects-pedals 800, the output ports 401, 402 can also be used to provide power to other devices such as to smart-phones 501, to tablets 502, to LED lights 850, which can be used to illuminate music, to the pedal-board, and to other power-consuming devices that might be useful to a musician.

Once the data has been transferred to a local computer 500, it can be manipulated within the local computer 500 or transmitted to a cloud computer 600. The cloud computer 600 is available for backing up data, performing additional computations, and a plurality of data-related actions, such as data analysis.

In some embodiments, the power-management system 100 uses a network router or similar device to connect directly to the cloud computer 600. The network router is either built into or external to the power-management system 100. As described in further detail below, once this data is stored on the cloud computer 600 or on the local computer 500, the musician can use it to carry out various tasks.

FIG. 3 shows the power-management system 100 connected to effects-pedals 800 that manipulate audio signals. Examples of effects-pedals 800 include delay pedals 801, distortion pedals 802, modulation pedals 803, equalization pedals 804, and tuning pedals 805. Effects-pedals 800 receive their power via a wired connection or via a wireless connection, such as via inductive power transfer.

Using the power-management system 100 with a computation device 500 that has a screen like a smart-phone 501 provides the musician with a convenient way control the effects-pedals 800, as well as to monitor status and analyze feedback.

For instance, on a battery-reliant power section 200, the power-management system 100 can alert the musician, via the screen of a smart-phone 501 for example, when the battery level falls to some threshold level. This level can be some default level or a level fixed by the musician. In addition, the level can be adaptively set and based on the power-management processor's analysis of the musician's habits. For example, the power-management processor 303 may collect historical data when the power-management system 100 is used and use that historical data to make predictions about how long the battery will last given the musician's habits.

In some embodiments, such historical data is stored, for example, on the cloud computer 600, which can analyze data over time and make recommendations to the musician via the local computer 500, or via the display 304. The information provided could include an estimate of battery drain rates in minutes of operation given prior performance analytics. Such data can be provided to a third party, such as a manufacturer. Since this data represents actual data about patterns of battery usage in the field, it would be useful as a basis for incorporating incremental improvements in battery design.

For example, when playing with a first band, a musician may play a style of music that draws heavily on the effects-pedals 800. In that case, the battery may give a limited amount of playing time. On the other hand, when playing in a second band, the same musician may play a style of music that makes only occasional use of the effects-pedals 800. In that case, the same battery level may yield considerably more playing time. In some embodiments, the musician tags performances to identify them, thus permitting the local computer 500 or cloud computer 600 to make predictions on required battery levels.

Yet another advantage of the foregoing apparatus is the ability to create presets. This is most easily carried out through software configuration. Depending on which pre-set a musician chooses, different variables will be associated with different input ports 403 and output ports 401, 402.

For instance, suppose a musician connects the delay pedal 801 to a first output port 401 and changes the output voltage of the first port 401 to 18 volts, perhaps because that voltage is appropriate for the delay pedal 801. The communication circuitry 305 then transmits that data, as well as data associated with all the other ports 402, 403, to the smart-phone 501. The smart-phone 501 then saves that information as a first pre-set that can be recalled later. A musician might then use this first preset for powering one pedal-board, and a second preset for a different pedal-board.

Or, the musician may choose from different pre-sets to control voltages at the same port 401, 402. For example, using pre-sets, a musician may cause the first output port to provide 9 volts to a distortion pedal 802 for one song, and then, in a subsequent song, cause its output to the same distortion pedal 802 to sag down to 7 volts, thus simulating the sometimes desirable audio effect of a dying battery when using certain effects pedals 800.

These changes can easily be made by choosing a pre-set on the smart phone 501 and causing the smart phone 501 to transmit this pre-set to the communication circuitry 305. The power-management processor 303 will then receive the pre-set and apply it to the appropriate output port 401. Alternatively, the musician can manually change the voltage outputs of different output ports 401, 402 by manipulating the control actuators 306.

An effects-pedal 800 may be damaged when one attempts to operate it at inappropriate voltages. In some embodiments, the power-management processor 303 knows the types of effects-pedals 800 connected to each output port 401, 402 and consults a table of allowable voltages for those effects-pedals 800. The power-management processor 303 then prevents an output port 401 connected to such an effects-pedal 800 from outputting a voltage that is outside the range of allowable voltages for that effects-pedal 800. In some cases, the power-management processor 303 receives user-input identifying which effects-pedals 800 are connected to which output ports 401, 402.

Software backups of state and function preferences can be saved to the local computer 500 or to the cloud computer 600, for recall and reloading on any compatible power-management system 100. The state and function preferences stored on the local computer 500 or on the cloud computer 600 can be transmitted to one or more social networks for sharing of presets and settings with other musicians and collaborators.

Although described herein with one input port 403 and two output ports 401, 402, a power-management system 100 can include any number of input ports 403 and output ports 401, 402.

Software executing on the local computer 500, the cloud computer 600, and/or the power-management processor 303 is stored on a tangible and non-transitory computer-readable medium in a non-abstract form. Such software takes the general abstract idea of control and implements it in a concrete and tangible manner by manipulating or operating a particular physical device that has mass and consumes electricity when in use.

It is to be understood that the foregoing description is intended to illustrate and not to limit the scope of the invention, which is defined by the scope of the appended claims. Other embodiments are within the scope of the following claims.

Having described the invention, and a preferred embodiment thereof, what is claimed as new, and secured by letters patent is:

1. An apparatus for managing power provided to musical effects-pedals, said apparatus comprising a power-management system, wherein said power-management system comprises a plurality of effects-pedal ports for providing power to each of a corresponding plurality of effects pedals, and a control system for controlling power supplied to each of said effects-pedal ports.

2. The apparatus of claim 1, further comprising an additional output port for supplying power to an auxiliary device.

3. The apparatus of claim 1, further comprising an additional output port for charging an auxiliary device.

4. The apparatus of claim 1, further comprising a battery pack for providing a time-varying voltage from which to derive said power supplied to each of said effects-pedal ports.

5. The apparatus of claim 4, wherein said control system is configured to provide an estimate of battery lifetime, said estimate being based at least in part on both battery level and historical data indicative of a rate at which effects-pedals consume power.

6. The apparatus of claim 4, wherein said control system is configured to maintain a count of battery charge cycles and to estimate battery lifetime at least in part on the basis of said count.

7. The apparatus of claim 4, wherein said control system is configured to issue an alert when estimated battery lifetime falls below a threshold.

8. The apparatus of claim 4, wherein said power-management system is configured to daisy chain multiple pedal boards.

9. The apparatus of claim 8, wherein said power-management system is configured to carry out power balancing if a first pedal board is consuming power faster than a second pedal board.

10. The apparatus of claim 1, further comprising a line input for providing a time-varying voltage from which to derive said power supplied to each of said effects-pedal ports.

11. The apparatus of claim 10, further comprising a power converter for transforming said time-varying voltage into a DC voltage for said effects-pedal ports.

12. The apparatus of claim 1, wherein said effects-pedal ports comprise a first effects-pedal port and a second effects-pedal port, and wherein said control system is configured to provide a first output on said first effects-pedal port and a second output on said second effects-pedal port, said first and second outputs differing from each other.

13. The apparatus of claim 12, wherein controller is configured to retrieve a pre-set from a set of pre-sets and to apply said pre-set to said effects-pedal ports, wherein said retrieved pre-set specifies said first and second outputs.

14. The apparatus of claim 1, wherein said control system is configured to respond to an instruction to apply a particular voltage to an effects-pedal port in a manner that is inconsistent with said instruction.

15. The apparatus of claim 1, further comprising a sensor for providing measurement data to said control system, and wherein said control system is configured to rely at least in part on said measurement data as a basis for control.

16. The apparatus of claim 15, wherein said sensor measures temperature.

17. The apparatus of claim 15, wherein said sensor measures voltage or current at each of said effects-pedal ports.

18. The apparatus of claim 1, wherein said control system is configured to avoid placing said power-management system in sleep mode while an effects-pedal is being used.

19. The apparatus of claim 1, further comprising an external computer having a tangible and non-transitory computer-readable medium having encoded thereon software per quod, said software per quod being configured execute a concrete implementation of an abstract idea on said external computer, said software per quod being configured to interface with said power-management system.

20. The apparatus of claim 1, wherein said software is configured to cause said power-management system to cease operation and to resume operation after having ceased operation.

21. The apparatus of claim 1, wherein said software is configured to cause said power-management system to enable sharing of pre-sets via a social network.

22. The apparatus of claim 1, wherein said software is configured to cause said power-management system to manage pre-sets for said output ports.

23. The apparatus of claim 1, wherein said software is configured to determine permissible outputs for a particular effects pedal.

24. The apparatus of claim 1, wherein said external computer comprises a smart-phone.

25. The apparatus of claim 1, wherein said external computer comprises a cloud computer.

26. The apparatus of claim 1, wherein said external computer comprises a local computer.

27. The apparatus of claim 1, further comprising an effects pedal connected to one of said effects-pedal ports.
